(19) United States
(12) Patent Application Publication
(10) Pub. No.: US 2006/0253560 A1
(43) Pub. Date: Nov. 9, 2006

(54) Method of gathering information relating to consumption of broadcast content by receiving stations

(76) Inventor: Janne Aaltonen, TURKU (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 10/539,988

(22) PCT Filed: Nov. 28, 2003
(86) PCT No.: PCT/IB03/05581

§ 371 Date: Jun. 17, 2005

(30) Foreign Application Priority Data
Dec. 19, 2002 (GB) 0229588.9

(51) Int. Cl. G06F 15/173

(52) U.S. Cl. 709/223

(57) ABSTRACT

In a 3G broadcasting network, an electronic service guide (ESG) is broadcast including descriptions of sessions in which items, such as multimedia streams, are broadcast. Each description of a session includes an instruction to a mobile station to notify the network if it wishes to receive or to continue receiving items included in the session. This can be used to generate ratings for the session and/or to broadcast the session only in cells in which users are interested in receiving items included in the session.

### FIELD OF INVENTION

The present invention relates to a method of gathering information relating to consumption of broadcast content by receiving stations.

### BACKGROUND ART

Third generation (3G) multicasting may be used to deliver point-to-multipoint content. For example, 3G multicasting may be used to provide services, such as news programs, to mobile stations.

Reference is made to 3^{rd} Generation Partnership Project, Technical Specification Group Services and System Aspects, Multimedia Broadcast/Multicast Service, Stage 1, Release 5 (3GPP TS22.146 V5.1.0) which describes schemes for collecting charging information for using multicast services.

Charging information may be collected on the basis of duration of a multicast session, times of joining and leaving a multicast subscription group, duration of membership of a multicast subscription group, times of joining and leaving a multicast group, duration of membership of a multicast group and volume of contents received during a multicast session.

In the examples just described, multicast joining and leaving messages may be used for collecting charging information. These messages naturally lend themselves to being used in this way since they are employed in the normal course of establishing a multicast session.

The examples described above may also be used to determine ratings and to obtain feedback during multicasting.

Other methods of determining audience ratings and obtaining feedback during multicasting are also known.

For example, a timer-based feed back mechanism for requesting periodic feedback of consumption of a multicast service is described in “Scalable feedback for large groups” by J. Normenmacher and E. W. Biersack, IEEE/ACM Transactions on Networking, pp. 375-386, Volume 7, Issue 3 (June 1999). A similar result is achieved using Scalable Reliable Multicast (SRM) protocol described in “A reliable multicast framework for light-weight sessions and application level framing” by S. Floyd, V. Jacobson, C. Liu, S. McCanne and L. Zhang, IEEE/ACM Transactions on Networking, volume 5, pp. 784-803 (December 1997). These methods can be used to start, maintain and stop transmission depending on the existence of the audience.

3G broadcasting and Internet protocol over terrestrial digital video broadcasting (IP over DVB-T) may also be used to deliver point-to-multipoint data.

However, broadcasting differs from multicasting in at least one respect, namely that transmission of content is initiated by a service provider or network and not by the user. Content is transmitted in broadcast cells according to a predefined schedule and users can opt either to receive or not to receive content. For example, a user may choose to receive a one program, but not another.

In broadcasting, it is desirable to generate ratings for programs for the purposes of billing users or charging advertisers. However, the methods of collecting charging information for using multicast services are not suited for use in broadcasting.

A satellite-based broadcasting system in which a broadcaster sends a Request for Feedback (RFB) to clients and the clients transmit feedback to a sever via a public land mobile network for determining size of audience is described in “Broadcast audience estimation” by Liu Chuanhai and J. Normenmacher, INFOCOM 2000, Proceedings of Nineteenth Annual Joint Conference of the IEEE Computer and Communications Societies, Volume 2, pp. 952-960 (2000).

The present invention seeks to provide a method of gathering information relating to consumption of broadcasted content by receiving stations.

### SUMMARY OF THE INVENTION

According to a first aspect of the present invention there is provided a method of gathering information relating to consumption of broadcast content by receiving stations, the method comprising preparing a schedule for broadcasting content, including, in the schedule, an instruction to notify a given party of consumption of content and transmitting the schedule to a plurality of receiving stations.

Transmitting the schedule to said plurality of receiving stations may comprise broadcasting the schedule to a plurality of receiving stations

According to a second aspect of the present invention there is provided a method of gathering information relating to consumption of broadcast content, the method comprising preparing a description of the content, adding to the description an instruction to notify a given party of intended reception of the content and transmitting the description to a plurality of receiving stations.

Transmitting the description to said plurality of receiving stations may comprise broadcasting the description to a plurality of receiving stations

This has the advantage that consumption of content can be recorded in real time.

The method may comprise including in the schedule or adding to the description an instruction to notify the given party of intended continued reception of the content and/or an instruction to notify the given party of intended cessation of reception of content.

The method may comprise broadcasting the content if a receiving station notifies the given party that it intends to receive the content. The method may comprise receiving notifications from receiving stations. The method may comprise counting a number of receiving stations which notify the given party that they intend to receive the content and/or counting a number of receiving stations which notify the given party that they are receiving the content.

The preparing of the description of the content may be according to the Session Description Protocol.

The method may comprise identifying a region from which a notifications is received and broadcasting the content in the region. The method may comprise identifying a region from which no notification is received and not broadcasting the content in the region.

According to a third aspect of the present invention there is provided a method, in a receiving station, of providing information relating to consumption of broadcast content, the method comprising receiving a schedule of broadcasting content, determining whether the schedule includes an instruction to notify a given party of consumption of content and, if the schedule includes the instruction, then transmitting a notification to the given party.

According to a fourth aspect of the present invention there is provided a method, in a receiving station, of providing information relating to consumption of broadcast content, the method comprising receiving a description of the content, determining whether an instruction has been added to the description, the instruction being to notify a given party of intended reception of the content and if the instruction is added to the description, then transmitting, to the given party, a notification of intended reception of the content.

The method may comprise receiving the content. The method may further comprise transmitting, to the given party, a notification of intended continued reception of the content and/or transmitting, to the given party, a notification of intended cessation of reception of the content.

According to a fifth aspect of the present invention there is provided a method of controlling a broadcasting network, said broadcasting network including a base station for broadcasting content in a predetermined region, the method comprising determining whether a notification of intended reception of broadcast content is received from a receiving station located in said predetermined region and if, said notification is received, broadcasting the content in the predetermined region.

The method may further comprising preparing a description of broadcast content adding to the description an instruction to notify a given party of intended reception of the content and transmitting the description to a plurality of receiving stations.

According to a sixth aspect of the present invention there is provided a method of controlling a broadcasting network, the broadcasting network including a base station for broadcasting content in a predetermined region, the method comprising counting a number of notifications of intended reception of broadcast content received from receiving stations located in said predetermined region and if, the number of notification equals or exceeds a predetermined number, broadcasting the content in the predetermined region.

The method may further comprise, if said number of notifications falls below said predetermined number, stopping broadcast of said content in said predetermined region.

A notification of intended reception of broadcast content may be used as a notification of intended continued reception of broadcast content.

According to a seventh aspect of the present invention there is provided apparatus for gathering information relating to consumption of broadcast content, the apparatus comprising means for preparing a description of the content, means for adding to the description an instruction to notify a given party of intended reception of the content and means for transmitting the description to a plurality of receiving stations.

According to a eighth aspect of the present invention there is provided a apparatus for gathering information relating to consumption of broadcast content, the apparatus comprising a processor for preparing a description of the content and adding to the description an instruction to notify a given party of intended reception of the content and a transmitter for transmitting the description to a plurality of receiving stations.

According to a ninth aspect of the present invention there is provided apparatus for controlling a broadcasting network, the broadcasting network including a content provider, a network element for routing content and a base station for broadcasting content in a predetermined region, the apparatus comprising means for receiving, from receiving station, a notification of intended reception of broadcast content, means for determining whether the notification is received from a receiving station located in the predetermined region and means for instructing the network element to route the content to the base station for transmission in the predetermined region.

According to a tenth aspect of the present invention there is provided apparatus for controlling a broadcasting network, the broadcasting network including a content provider, a network element for routing content and a base station for broadcasting content in a predetermined region, the apparatus comprising a receiver for receiving, from receiving station, a notification of intended reception of broadcast content, a processor for determining whether the notification is received from a receiving station located in the predetermined region and transmitter for instructing the network element to route the content to the base station for transmission in the predetermined region.

According to an eleventh aspect of the present invention there is provided a receiving station for providing information relating to consumption of broadcast content, the receiving station comprising means for receiving a description of the content, means for determining whether an instruction has been added to the description, the instruction being to notify a given party of intended reception of the content; and means for transmitting, to the given party, a notification of intended reception of the content if the instruction is added to the description.

According to a thirteenth aspect of the present invention there is provided a receiving station for providing information relating to consumption of broadcast content, the receiving station comprising a receiver for receiving a description of the content, a processor for determining whether an instruction has been added to the description, the instruction being to notify a given party of intended reception of the content and a transmitter for transmitting, to the given patty, a notification of intended reception of the content if the instruction is added to the description.

According to a fourteenth aspect of the present invention there is provided a system for presenting program schedule data on a display of receiving station, said system comprising at least a schedule data for broadcasting content, the schedule data being organized to include at least partly an instruction to notify a given party of consumption of content.

The transmitting may be multicasting.

According to a fifteenth aspect of the present invention there is provided a computer program which, when executed by a data processing apparatus, causes said data processing apparatus to perform the method.

According to a sixteenth aspect of the present invention there is provided a computer program product storing the computer program.

According to a seventeenth aspect of the present invention there is provided a signal carrying the computer program.

According to an eighteenth aspect of the present invention there is provided a signal carrying a schedule or description of broadcast content which includes an instruction to notify a given party of consumption of content.

The signal may be electrical or optical. The signal may be a radio signal.

### BRIEF DESCRIPTION OF THE DRAWINGS

Embodiments of the present invention will now be described with reference to the accompanying drawings in which:

FIG. 1 is a schematic diagram of a system for transmitting content to a plurality of mobile stations;

FIG. 2 is a schematic diagram of a service delivery platform;

FIG. 3 is a schematic diagram of a ratings centre;

FIG. 4 is a schematic diagram of mobile station circuitry;

FIG. 5 is a schematic diagram of mobile station functionality;

FIG. 6 shows a service hierarchy;

FIG. 7 shows a service program;

FIG. 8 illustrates transmission of an electronic service guide;

FIG. 9 is a schematic diagram of a session announcement;

FIG. 10 illustrates a first process for providing content;

FIG. 11 shows transmission of items during sessions;

FIG. 12 is a process flow diagram of a method of operating a mobile station;

FIG. 13 is a schematic diagram of a notification transmitted by a mobile station;

FIG. 14 illustrates a second process for providing content;

FIG. 15 is a process flow diagram of a method of operating a ratings centre;

FIG. 16 is a process flow diagram of a method of operating a network element;

FIG. 17 is a schematic diagram of another system for transmitting content to a plurality of mobile stations;

FIG. 18 is a schematic diagram of another mobile station; and

FIG. 19 is a schematic diagram of another system for transmitting content to a receiver.

### DETAILED DESCRIPTION OF THE INVENTION

System for Delivering Broadcast Content

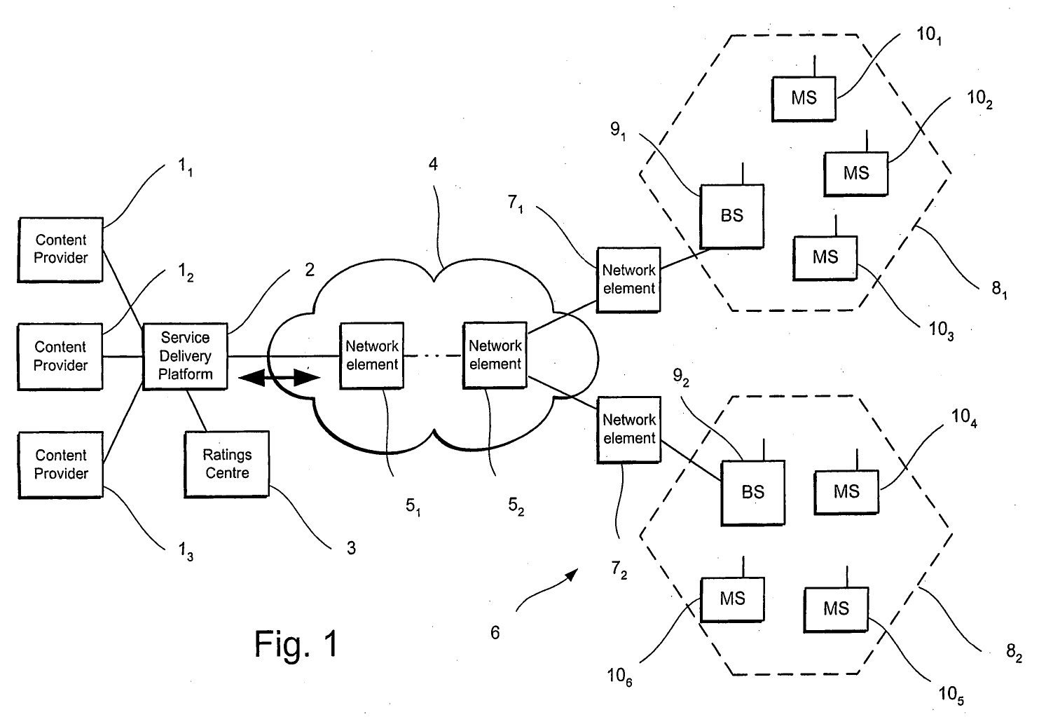

Referring to FIG. 1, a system for delivering broadcast content is shown. The broadcasting system includes at least one content provider 1₁, 1₂, 1₃, a service delivery platform 2, a ratings centre 3, a core network 4, which includes at least one network element 5₁, 5₂, and an access network 6. The access network 6 includes at least one network element 7₁, 7₂ and at least one wireless cell 8₁, 8₂ served by respective base stations 9₁, 9₂ and which can transmit signals to respective sets of receiving stations in the form of mobile stations 10₁, 10₂, 10₃, 10₄, 10₅, 10₆.

A broadcasting system can be considered to be different from a multicasting system in that a provider, not a consumer, initiates delivery of content. However, as will be explained in more detail later, the provider may initiate broadcasting in some areas but not others according to the number of the consumers present and wishing to receive content in each area.

In this example, the core and access networks 4, 6 are included in a universal mobile telephone system (UMTS) for delivering broadcast content. In this example, aspects relating to the use of UMTS as a system for broadcasting are described.

The core network 4 is a packet-based network and the network elements 5₁, 5₂ are a gateway general packet radio service (GPRS) service node (GGSN) and a serving GPRS service node (SGSN) respectively.

The access network 6 is also a packet-based network and the network elements 7₁, 7₂ are radio network controllers (RNC). The base stations 9₁, 9₂ each comprise a base station node B for transmitting and receiving signals according to a wideband code division multiple access (WCDMA) specification.

Service Delivery Platform 2

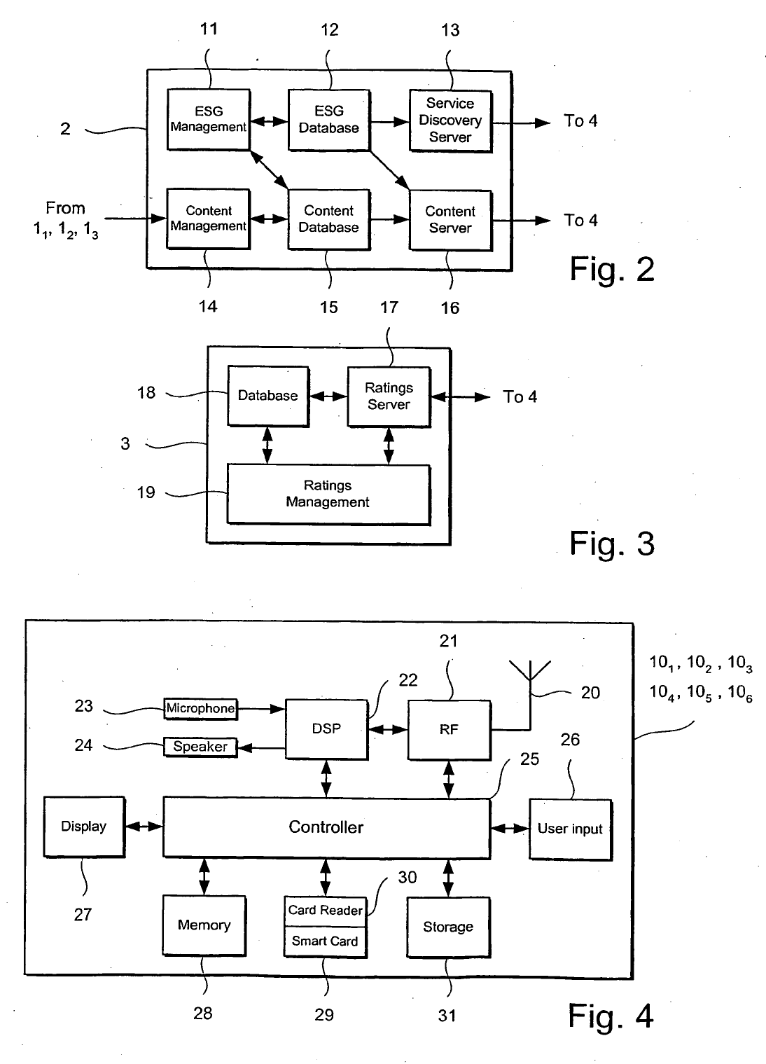

Referring to FIG. 2, functional elements of the service delivery platform 2 are shown. The service delivery platform 2 includes an electronic service guide (ESG) management module 11 for allowing an administrator (not shown) to control metadata for describing content, an ESG database 12 for storing metadata for the ESG, a service discovery server 13 for generating and providing announcements of services and sessions, a content management module 14 for allowing the administrator to add, replace and delete content items for transmission, a contents database 15 for storing or buffering content for transmission and a content server 16 for providing content.

Ratings Centre 3

Referring to FIG. 3, functional elements of the ratings centre 3 are shown. The ratings centre 3 may include a ratings server 17, a database 18 and a management module 19. The rating centre 3 may be integrated or collocated with the service delivery platform 2. Alternatively, it may be integrated or collocated with a network element 51, 52 or be located at a different site.

Mobile Station 10₁, 10₂, 10₃, 10₄, 10₅, 10₆

Referring to FIG. 4, a mobile station 10₁, 10₂, 10₃, 10₄, 10₅, 10₆ is shown in more detail. The mobile station 10₁, 10₂, 10₃, 10₄, 10₅, 10₆ includes an antenna 20, a radio frequency section 21 for, inter alia, modulating/de-modualting and amplifying signals, a signal processor 22 for, inter alia, coding/decoding signals, a microphone 23, a speaker 24, a controller 24, a user input 25, such as a keypad, a display 26, memory 27, a smart card 28, such as a universal subscriber identification module (USIM) 29, a smart card reader 30 and, optionally, storage 31, which may be non-volatile memory. The mobile station 10₁, 10₂, 10₃, 10₄, 10₅, 10₆ is powered by a battery (not shown).

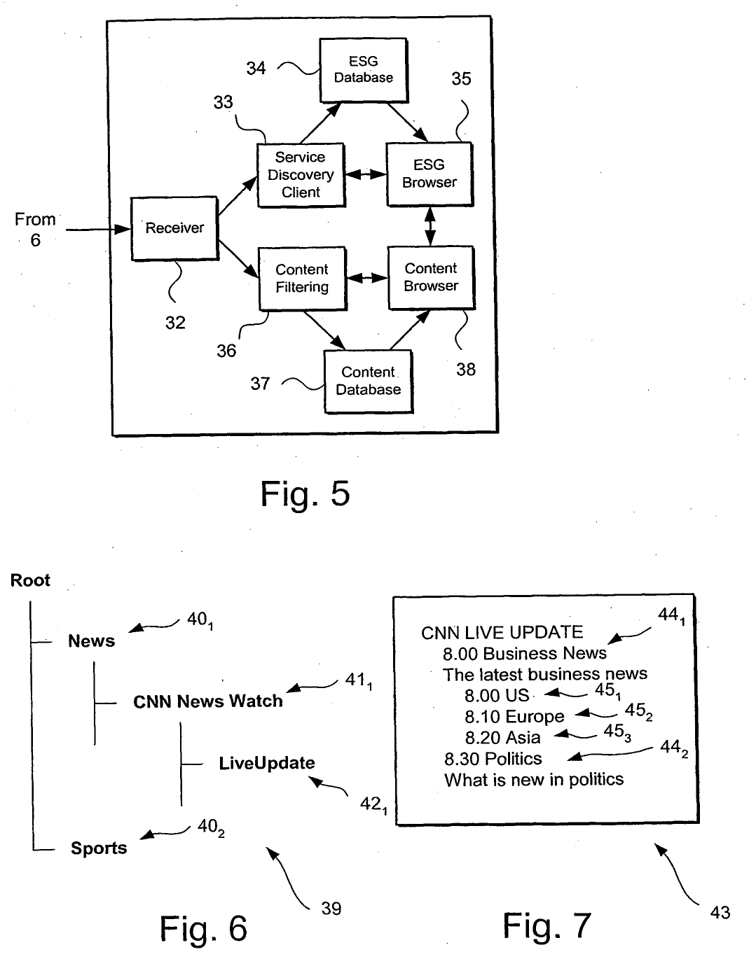

Referring to FIG. 5, functional elements of the mobile station 10₁, 10₂, 10₃, 10₄, 10₅, 10₆ are shown. The mobile station 10₁, 10₂, 10₃, 10₄, 10₅, 10₆ includes a receiver 32, a service discovery client 33, an ESG database 34 for storing the ESG, an ESG browser 35, content filtering application 36, a content database 37 for storing content and a content browser 38.

The receiver 34 receives, demodulates and decapsulates data received from the access network 6. The demodulated and decapsulated data is forwarded to an IP stack (not shown). The demodulated and decapsulated data comprises IP packets carrying content streams or metadata describing content. The IP packets are forwarded to IP-based applications, such as the service discovery client 33 or content filtering application 36, running on the mobile station 10₁, 10₂, 10₃, 10₄, 10₅, 10₆.

The service discovery client 33 receives IP packets carrying the ESG. The IP packets carry metadata which can be stored in the ESG database 34 or forwarded directly to the ESG browser 35.

The ESG database 34 may be held in memory 28 or storage 31 (FIG. 4). When the mobile station 10₁, 10₂, 10₃, 10₄, 10₅, 10₆ is first switched on, the ESG database 34 is usually empty. However, the ESG database 34 fills up and is updated as the ESG is received.

The ESG browser 35 allows a user to view schedules and descriptions of services, sessions and content items available from the service delivery platform 2 (FIG. 1). The ESG browser 35 can retrieve metadata from the ESG database 34 or receive updates directly from the service discovery client 33.

The content filtering application 36 receives IP packets on one or more given addresses and one or more given ports configured by the content browser 38 or other applications running. The IP packets carry content which can be stored in the content database 37 or forwarded directly to the content browser 38.

The content browser 38 is usually loaded and run when the user selects selected a particular content item for consumption. The content item can be received in real time or retrieved from the content database 37. The content browser 38 can be for example a Web browser, an MP3 player or a streaming video client.

Electronic Service Guide (ESG)

An ESG is used to inform users about services which are available. The services are arranged according to a hierarchy to help users find services in which he or she may be interested. Each service may comprise one or more sessions which include at least one item. An item may include text, audio, video file or other data types. An item may also comprise two or more types of data, such as a video and audio. The ESG includes information about the hierarchy of services and information about items transmitted during a session.

Referring to FIG. 6, a hierarchy 39 of available services is shown. The hierarchy 39 includes categories 40₁, 40₂. Examples of first and second categories 40₁, 40₂ are news and sports respectively. Categories 40₁, 40₂ may in turn be divided into sub-categories (not shown). Categories 40₁ may include at least one service set 41₁ which may include at least one service 42₁.

A service set 41₁ groups together services 42₁ of same or similar type, usually provided or owned by one service provider or content provider. The service provider or content provider may provide or own a plurality of service sets 41₁. A service 42₁ may be included in a plurality of service sets 41₁. In this example, the first category 40₁ includes a service set 41₁ labelled “CNN News Watch” which includes a service 42₁ called “Live Update”.

Referring to FIG. 7, the ESG browser 35 (FIG. 5) can be used to display a schedule 43 and to examine in detail a service 42₁. The service 421 may include at least one session 44₁, 44₂ which may include at least one item 45₁, 45₂, 45₃. For example, the “Live Update” service 42₁ provided by “CNN News Watch” service set 34₁ may include a session or program 44₁ labelled “Business News” which includes items 45₁, 45₂, 45₃ relating to business news in US, Europe and Asia respectively. The session 44₁ is scheduled to begin and end at given times. Items 45₁, 45₂, 45₃ may also be scheduled.

The hierarchy 39 of categories 40₁, service sets 41₁ and services 42₁ usually does not change on a daily or weekly basis. However, sessions 44₁, 44₂ and items 45₁, 45₂, 45₃ may change on a daily basis.

Hierarchy and Session Announcements

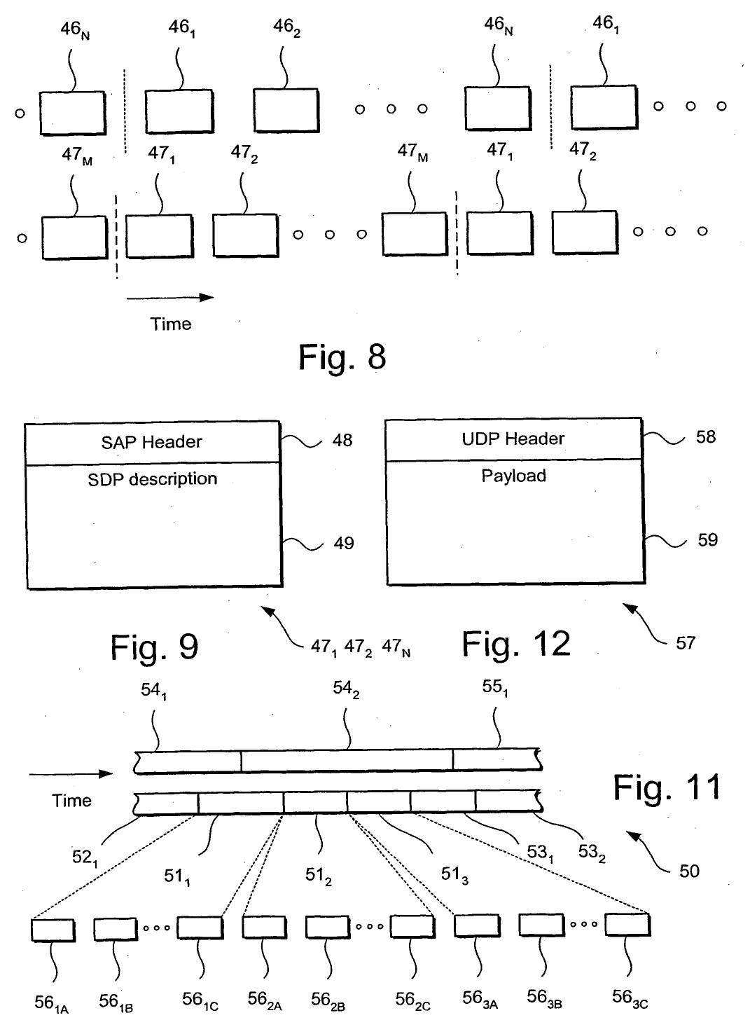

Referring to FIG. 8, the ESG includes two types of announcements, namely hierarchy announcements 46₁, 46₂, 46_{N} and session announcements 47₁, 47₂, 47_{M}. Each set of announcements 46₁, 46₂, 46_{N} is transmitted using a carousel (not shown). In other words, announcements 46₁, 46₂, 46_{N} are transmitted one after another. When all the announcements 46₁, 46₂, 46_{N} have been sent, the carousel starts to send the announcements again 46₁, 46₂, 46_{N}. In this example, the service discovery server 13 (FIG. 2) provides one carousel for each type of announcement. It may also provide additional carousels (not shown) for main pages and alerts.

A mobile station 10₁, 10₂, 10₃, 10₄, 10₅, 10₆ listens to announcements 46₁, 46₂, 46_{N}, 47₁, 47₂, 47_{M} so as to acquire the ESG.

Announcements 46₁, 46₂, 46_{N}, 47₁, 47₂, 47_{M} are transmitted through the core network 4 and access network 6 over an IP control channel (IP-CC).

When a mobile station 10₁, 10₂, 10₃, 10₄, 10₅, 10₆ is switched on, it usually does not have any ESG information. Therefore, the mobile station 10₁, 10₂, 10₃, 10₄, 10₅, 10₆ starts ESG discovery.

ESG discovery includes obtaining an IP address for receiving hierarchy announcements 46₁, 46₂, 46_{N}. Usually, the IP address is obtained by listening to a default IP address. Once a mobile station 10₁, 10₂, 10₃, 10₄, 10₅, 10₆ knows the address on which the hierarchy announcements 46₁, 46₂, 46_{N} are transmitted, it listens for hierarchy announcements 46₁, 46₂, 46_{N}.

The hierarchy announcements 46₁, 46₂, 46_{N} provide a hierarchy file (not shown) describing the hierarchy 39 (FIG. 6). The hierarchy file may take the form of an XML file.

The hierarchy announcements 46₁, 46₂, 46_{N} also provide an IP address for receiving session announcements 47₁, 47₂, 47_{M} Once a mobile station 10₁, 10₂, 10₃, 10₄, 10₅, 10₆ knows the address on which the session announcements 47₁, 47₂, 47_{N} are transmitted, it listens for session announcements 47₁, 47₂, 47_{N}.

Optionally, the process may include receiving main page and alert announcements (not shown) and announcements (not shown) for providing more details of services, sessions and items.

Referring to FIG. 9, a session announcement 47₁, 47₂, 47_{M} is shown in more detail. Each session announcement 47₁, 47₂, 47_{M} includes a header 48 and a description 49 of a respective session 44₁ and items 45₁, 45₂, 45_{M} included in the session 44₁.

In this example, Session Announcement Protocol (SAP) is used to transmit session announcements 47₁, 47₂, 47_{M} and Session Description Protocol (SDP) is used to describe the session 44₁ and session items 45₁, 45₂, 45_{M} Reference is made to “Session Announcement Protocol” by M. P. Maher, C. Perkins & E. Whelan, RFC 2974, IETF, October 2000 and to “Session Description Protocol” by M. Handley & V. Jacobson, RFC 2327, IETF, April 1998.

The description 49 may include a session identifier (session ID) for uniquely identifying the session, a session name, a category identifier (category ID) for identifying the, or each, category to which the session belongs, a service identifier (service ID) for identifying the, or each, service to which the session belongs, start and stop times for scheduling the session, a session description, a universal resource locator (URL) for a more detailed description, a URL for purchasing, a protection identifier (protection ID), a maximum bit rate of the session, data for identifying a MIME type from which it possible to identify a target application and/or a priority value for resolving filtering and Quality of Service (QoS) problems. The description 49 may also include additional arguments or fields for applications such as information for parental rating and genre classification.

The description 49 may also include at least one IP address and at least one port number for receiving service items.

The description 49 may also include information on the, or each item, such as a URL for more detailed information for respective items, an item identifier (item ID) for uniquely identifying an item, start and stop times for scheduling the item, a description of the item, a URL for voting and a maximum bit rate for the item. The description 42 may also include additional arguments, such as information for parental rating and classifying the item type.

A list of field types is found in “Session Announcement Protocol” ibid.

As will now be described in more detail, a schedule provided by an ESG and broadcast to end-users includes a request or instruction to end-users to provide feedback. Resulting feedback from end-users can be used to determine audience ratings. Furthermore, the feedback can also be used to select areas in which to broadcast content. For example, if no feedback is received in a particular area, then content need not be broadcast in that area.

Instruction to Send Notification

A message, hereinafter referred to as an instruction, is included in the description 49 for instructing a mobile station 10₁, 10₂, 10₃, 10₄, 10₅, 10₆ to transmit a notification if the mobile station 10₁, 10₂, 10₃, 10₄, 10₅, 10₆ wishes to receive the session, to transmit a notification if the mobile station 10₁, 10₂, 10₃, 10₄, 10₅, 10₆ wishes to continue receiving the session and/or to transmit a notification if the mobile station 10₁, 10₂, 10₃, 10₄, 10₅, 10₆ wishes to cease receiving a session. Separate instructions may be used. The instruction may also specify a time interval between which notifications should be transmitted.

In this example, an SDP category field is used and the instruction takes the form:

a=x-monitoringFlag:<value><time>

where <value>=1 if the mobile station 10₁, 10₂, 10₃, 10₄, 10₅, 10₆ is instructed to transmit notifications and <time> is time interval the mobile station 10₁, 10₂, 10₃, 10₄, 10₅, 10₆ should wait between transmitting notifications.

The instruction may also include information for identifying to whom the notification should be transmitted. For example, this may be a URL and so the instruction may take the form:

a=X-monitoringFlag:<value><time>

a=x-monitoringFlagURL:<url>

In this case, the URL is that of the ratings server 17 (FIG. 3). Other labels may be used instead of “monitoringFlag”.

Further instructions may be included in the description 49 for instructing the mobile station 10₁, 10₂, 10₃, 10₄, 10₅, 10₆ to transmit a notification if the mobile station 10₁, 10₂, 10₃, 10₄, 10₅, 10₆ wishes to receive an item, to transmit a notification if the mobile station 10₁, 10₂, 10₃, 10₄, 10₅, 10₆ wishes to continue receiving an item and/or to transmit a notification if the mobile station 10₁, 10₂, 10₃, 10₄, 10₅, 10₆ wishes to cease receiving an item. The, or each, further instruction may also specify a time interval between which notifications should be transmitted.

Thus, for each item, a further instruction may take the form:

a=X-itemId:<item_id>

a=X-monitoringFlag:<value><time>

a=X-monitoringFlagURL:<url>

The mobile station 10₁, 10₂, 10₃, 10₄, 10₅, 10₆ is provided with a routine for interpreting the instruction and any further instructions included in the description 49.

For example, a routine may include:

IF monitoringFlag=1

startransmissionFlag=1
continuetransmissionFlag=1
timeinterval=time
finishtransmissionFlag=1

end

If the mobile station 10₁, 10₂, 10₃, 10₄, 10₅, 10₆ wants to receive content or continue receiving content, then a flag “receivecontentFlag” may be set.

Thus, the routine may also include:

IF receivecontentFlag=1 and startransmissionFlag=1

send message “Start receiving content”

end
IF receivecontentFlag=1 and finishtransmissionFlag=1

send message “Finish receiving content”

end
IF receivecontentFlag=1 and scontinuetransmissionFlag=1

send message “Continue receiving content”

end

Thus, the message is used to instruct or request mobile stations 10₁, 10₂, 10₃, 10₄, 10₅, 10₆ to provide feedback. The resulting feedback can be used to generate audience ratings and/or to select areas in which to broadcast content, as will now be described in more detail:

Method of Generating Ratings

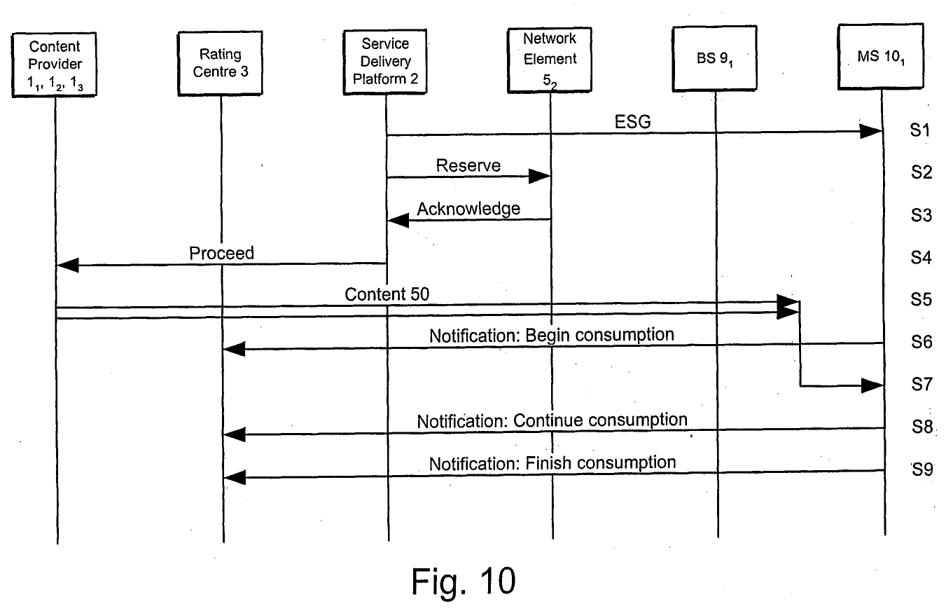

Referring to FIG. 10, a method of generating ratings is shown.

The service delivery platform 2 prepares an ESG. This includes preparing session announcements including descriptions of sessions. The service delivery platform 2 checks whether each session is to be rated, and if so, includes an instruction for instructing a mobile station 10₁, 10₂, 10₃, 10₄, 10₅, 10₆ to transmit respective notifications if the mobile station 10₁, 10₂, 10₃, 10₄, 10₅, 10₆ wishes to receive the session, to continue receiving the session and to cease receiving the session.

In this case, an instruction is to be included in each of the descriptions for the first and second sessions 44₁, 44₂. Each description takes the form of an SDP description and the instruction takes the form of an SDP category field as described earlier.

The service delivery platform 2 transmits the ESG (step S1).

The ESG is broadcast to mobile stations 10₁, 10₂, 10₃, 10₄, 10₅, 10₆ in cells 81, 82. Taking the first mobile station 10₁ as an example, the first mobile station 10₁ receives the ESG and for each session and, optionally, for each item in each session, checks whether there is an instruction to transmit a notification.

In this example, the ESG is included in the hierarchy and session announcements 46₁, 46₂, 46_{M}, 47₁, 47₂, 47_{M} (FIG. 8). The first and second session announcements 47₁, 47₂ include descriptions of first and second sessions 44₁, 44₂ (FIG. 7). The mobile station 10₁ examines the description 49 included in the session announcements 47₁, 47₂ and checks whether there is an instruction to notify the ratings centre 3. In other words, it checks whether the “a=X-monitoringFlag” is present. It also checks whether there are any another similar fields with additional instructions.

The service delivery platform 2 also transmits a message to the SGSN 5₂ requesting that the SGSN 5₂ reserve bandwidth for transmitting content (step S2). The SGSN 5₂ reserves the bandwidth and returns an acknowledgement to the service delivery platform 2 (step S3). The service delivery platform 2, if it has not done so already, sends a message to the, or each content provider 1₁, 1₂, 1₃, instructing them to transmit content (step S4).

The service delivery platform 2 transmits content (step S5).

Referring also to FIG. 11, content 50 includes content 51₁, 51₂, 51₃ for each item 45₁, 45₂, 45₃ (FIG. 7) included in the first session 44₁ (FIG. 7) and content 52₁, 53₁, 53₂, 54₁, 54₂, 55₁ for other items included in other sessions (not shown) some of which may or may not be transmitted simultaneously. Content for each item comprises IP packets. For example, content 51₁ for the first item 45₁ (FIG. 7) comprises a plurality of IP packets 56_{1A}, 56_{1B}, 56_{1C}. Content 51₂ for the second item 45₂ (FIG. 7) comprises a plurality of IP packets 56_{2A}, 56_{2B}, 56_{2C} and content 513 for the second item 45₃ (FIG. 7) comprises a plurality of IP packets 56_{3A}, 56_{3B}, 56_{3C}.

Content 50 is transmitted via the service delivery platform 2, through the core network 4 (FIG. 1), to the access network 6 (FIG. 1) which broadcasts the IP packets 56_{1A}, 56_{1B}, 56_{1C}, 56_{2A}, 56_{2B}, 56_{2C}, 56_{3A}, 56_{3B}, 56_{3C} in cells 8₁, 8₂ using base stations 9₁, 9₂ (step S5). Until the mobile station 101 is instructed to do so by its user, the mobile station 10₁ does not receive, filters out or ignores IP packets 56_{1A}, 56_{1B}, 56_{1C}, 56_{2A}, 56_{2B}, 56_{2C}, 56_{3A}, 56_{3B}, 56_{3C} carrying content 51₁, 51₂, 51₃ relating to the session 44₁,

The mobile station 10₁, 10₂, 10₃, 10₄, 10₅, 10₆ transmits a notification that it wishes to start consuming content in respect of which it has been instructed to send a notification (step S6). In this example, this is done as follows:

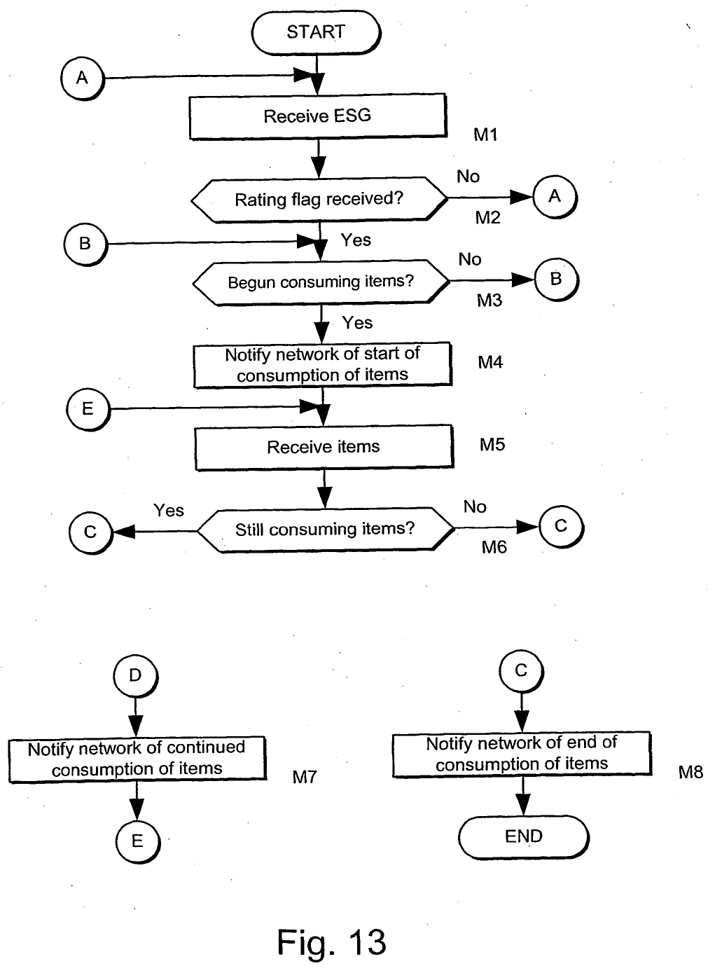

The user, via the ESG browser 35 (FIG. 5), indicates that he or she wishes to watch the Business News, in other words consume items 45₁, 45₂, 45₃ included in the first session 44₁. The mobile station 101 transmits a notification 57 (FIG. 13) to the ratings centre 3 notifying the ratings centre 3 that it is beginning to consume items 45₁, 45₂, 45₃ included in the first session 44₁ (FIG. 7) (steps S6).

Referring to FIG. 12, a notification 57 is in the form of a user datagram protocol (UDP) packet and includes a header 58 and payload 59 which includes data for identifying the first session 44₁ and data for identifying whether consumption is beginning, continuing or ending.

Referring again to FIGS. 10 and 11, the mobile station 10₁, 10₂, 10₃, 10₄, 10₅, 10₆ starts to receive content in respect of which it has been instructed to send a notification (step S7).

In this example, the mobile station 101 begins to receive and parse IP packets 56_{1A}, 56_{1B}, 56_{1C}, 56_{2A}, 56_{2B}, 56_{2C}, 56_{3A}, 56_{3B}, 56_{3C} carrying content relating to items 45₁, 45₂, 45₃ in the first sessions 44₁ to content database 37 (FIG. 5) for storing and/or to content browser 38 (FIG. 5) for immediate presentation to the user.

The mobile station 10₁, 10₂, 10₃, 10₄, 10₅, 10₆ transmits a notification that it is continuing to consume the content (step S8).

In this case, while the mobile station 10₁ receives and parses IP packets 56_{1A}, 56_{1B}, 56_{1C}, 56_{2A}, 56_{2B}, 56_{2C}, 56_{3A}, 56_{3B}, 56_{3C} carrying content relating to items 45₁, 45₂, 45₃ (FIG. 7) in the first sessions 44₁ (FIG. 7), it periodically send a notification 57 (FIG. 13) to the ratings centre 3 informing the ratings centre 3 that it is still consuming items 45₁, 45₂, 45₃.

The mobile station 10₁, 10₂, 10₃, 10₄, 10₅, 10₆ transmits a notification that it is finished consuming content (step S9). In this example, this is done as follows:

The user indicates that he or she no longer wishes to watch the Business News. This may be down my entering a command through the content browser 38 (FIG. 5).

The mobile terminal 101 ceases to receive and parse the IP packets 56_{1A}, 56_{1B}, 56_{1C}, 56_{2A}, 56_{2B}, 56_{2C}, 56_{3A}, 56_{3B}, 56_{3C} and so it sends a notification 57 (FIG. 13) to the ratings centre 3 that it is has finished consuming items 45₁, 45₂, 45₃ (FIG. 7).

It will be understood, that more than one mobile station 10₁, 10₂, 10₃, 10₄, 10₅, 106 may want to receive items 45₁, 45₂, 45₃ (FIG. 7) included in the first session 44₁ (FIG. 7) and so more than one sets of notifications 57 (FIG. 13) may be sent to the ratings centre 3.

The process hereinbefore described may be used to charge each mobile station 10₁, 10₂, 10₃, 10₄, 10₅, 10₆ for accessing a service.

The process may be used to generate ratings. The ratings centre 3 collects notifications 57 (FIG. 13) relating to the same session or item, such as the first session 441 (FIG. 7), and counts the notifications 57. In this way, the ratings centre 3 can determine how many mobile stations 10₁, 10₂, 10₃, 10₄, 10₅, 106 consumed the session 44₁ (FIG. 7). If advertisements are displayed or played during the session 44₁ (FIG. 7) or item 45₁, 45₂, 45₃ (FIG. 7), then, using the ratings, a corresponding charge may be calculated.

The process has the advantage that ratings can be generated in real time.

Method of Operating the Mobile Station 10₁, 10₂, 10₃, 10₄, 10₅, 10₆

Referring to FIG. 13, a method of operating the mobile station 10₁, 10₂, 10₃, 10₄, 10₅, 10₆ is shown.

The mobile station 10₁, 10₂, 10₃, 10₄, 10₅, 10₆ receives the ESG (step M1).

In this case, the ESG is included in hierarchy and session announcements 46₁, 46₂, 46_{M}, 47₁, 47₂, 47_{M} (FIG. 8). The first and second session announcements 471, 472 (FIG. 8) include descriptions of the first and second sessions 44₁, 44₂ (FIG. 7).

For each session and, optionally, for each item in each session, the mobile station 10₁, 10₂, 10₃, 10₄, 10₅, 10₆ checks whether there is an instruction to transmit a notification (step M2).

In this example, the mobile station 10₁, 10₂, 10₃, 10₄, 10₅, 10₆ examines the description 48 included in the session announcements 47₁, 47₂ and checks whether there is an instruction to notify the ratings centre 3. In other words, it checks whether the “a=x-monitoringFag” is set. It also checks whether there are any another similar fields with additional instructions.

The mobile station 10₁, 10₂, 10₃, 10₄, 10₅, 10₆ determines whether it is to participate in a session (step M3) and, if instructed to send a notification, transmits a notification (step M4).

In this example, the user, via the ESG browser 35 (FIG. 5), indicates that he or she wishes to watch the Business News, in other words consume items 45₁, 45₂, 45₃ included in the first session 44₁. The mobile station 10₁, 10₂, 10₃, 10₄, 10₅, 10₆ checks whether it has been instructed to send a notification and since “a=X-monitoringFlag” is set, transmits the notification 57 (FIG. 12) to the ratings server 3.

The mobile station 10₁, 10₂, 10₃, 10₄, 10₅, 10₆ begins to receive content in respect of which it has sent a notification (step M5).

In this instance, the mobile station 10₁, 10₂, 10₃, 10₄, 10₅, 10₆ begins to receive and parse IP packets 56_{1A}, 56_{1B}, 56_{1C}, 56_{2A}, 56_{2B}, 56_{2C}, 56_{3A}, 56_{3B}, 56_{3C} (FIG. 11) carrying content relating to items 45₁, 45₂, 45₃ (FIG. 7) in the first session 441 (FIG. 7) to the content database 37 (FIG. 2) for storing and/or to content browser 38 (FIG. 2) for immediate presentation to the user.

The mobile station 10₁, 10₂, 10₃, 10₄, 10₅, 10₆ checks whether it is still consuming content in respect of which it has sent a notification (step M6). If so, it sends a notification that it is still consuming content (step M7). If not, it sends a notification that it will cease or has ceased consuming content (step M8).

For example, while the mobile station 10₁, 10₂, 10₃, 10₄, 10₅, 10₆ receives and parses IP packets 56_{1A}, 56_{1B}, 56_{1C}, 56_{2A}, 56_{2B}, 56_{2C}, 56_{3A}, 56_{3B}, 56_{3C} (FIG. 11), it periodically sends a notification 57 (FIG. 13) to the ratings centre 3 informing the ratings centre 3 that it is still consuming items 45₁, 45₂, 45₃ (FIG. 7) included in the first session 44₁.

When the mobile terminal 10₁, 10₂, 10₃, 10₄, 10₅, 10₆ ceases to receive and parse the IP packets 56_{1A}, 56_{1B}, 56_{1C}, 56_{2A}, 56_{2B}, 56_{2C}, 56_{3A}, 56_{3B}, 56_{3C}, it sends a notification 57 (FIG. 13) to the ratings centre 3 that it is has finished consuming items 45₁, 45₂, 45₃ (FIG. 7).

Method of Controlling Broadcasting

Notifications 57 (FIG. 13) may also be used to control in which regions or areas content is broadcasted. Thus, content may be broadcasted in regions in which mobile stations 10₁, 10₂, 10₃, 10₄, 10₅, 10₆ wish to consume the content.

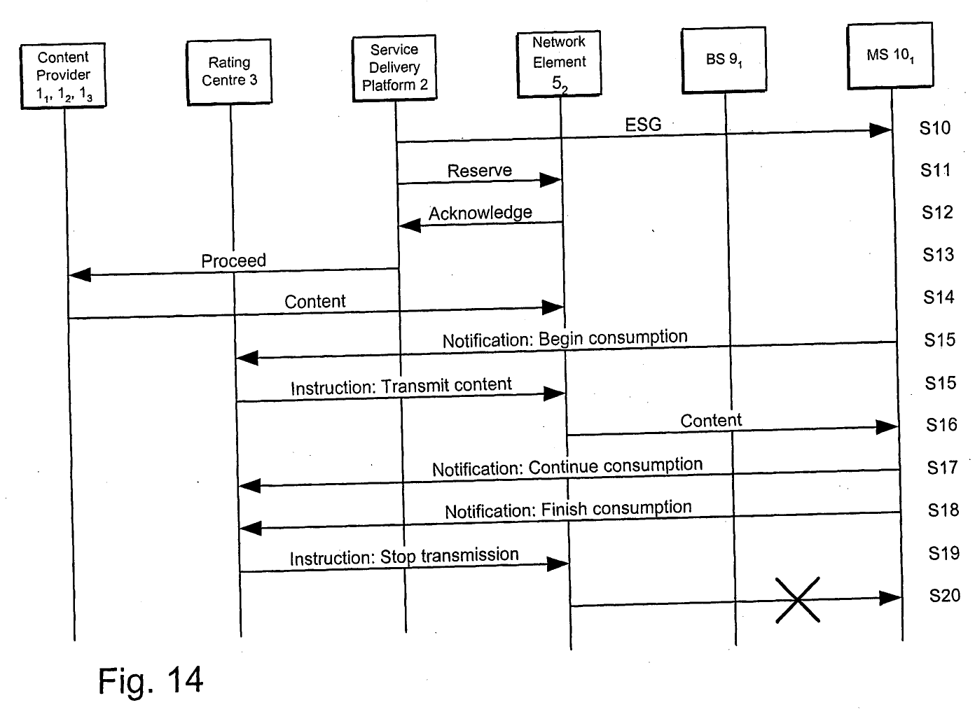

Referring to FIG. 14, a method of controlling broadcasting is shown.

An ESG is prepared and the service delivery platform 2 and SGSN 5₂ perform steps S1 to S4 as described earlier (steps S10 to S13).

Content 50 (FIG. 11) is transmitted to a network element, in this case the SGSN 5₂, where it is stored (step S14). It is not automatically forwarded to the base stations 9₁, 9₂ for transmission to the mobile stations 10₁, 10₂, 10₃, 10₄, 10₅, 10₆.

A user, via the ESG browser 35 (FIG. 5), indicates that he or she wishes to watch the Business News, in other words consume items 45₁, 45₂, 45₃ included in the first session 44₁.

The mobile station 10₁, 10₂, 10₃, 10₄, 10₅, 10₆ transmits a notification that it wishes to start consuming content in respect of which it has been instructed to send a notification (step S15).

In this example, the mobile station 101 transmits a notification 57 (FIG. 13) to the ratings centre 3 that it is beginning to consume items 45₁, 45₂, 45₃ included in the first session 44₁ as described earlier.

The ratings centre 3 transmits an instruction to the network element to forward content provided a minimum number of mobile stations 10₁, 10₂, 10₃, 10₄, 10₅, 106 send notifications (step S16).

The ratings centre 3 listens for notifications 57. Notifications 57 are grouped according to sessions and/or items and also according to cells 8₁, 8₂ and are counted. If a counted number of mobile stations wishing to consume the same session or item in the same cell 8₁, 8₂ equals or exceeds a predetermined minimum number, which is usually set to one, then the ratings centre 3 transmits an instruction to the SGSN 5₂ to transmit corresponding content 50 in the cell 8₁, 8₂ (step R3). Thus, in this example, if a notification 57 is received from the mobile station 10₁ located in the first cell 8₁ indicating that it wishes to consume items included in the first session 44₁, then an instruction is sent to the SGSN 5₂ to transmit IP packets 56_{1A}, 56_{1B}, 56_{1C}, 56_{2A}, 56_{2B}, 56_{2C}, 56_{3A}, 56_{3B}, 56_{3C} in the first cell 81.

The SGSN 5₂ receives the instruction from the ratings centre 3 and forwards the corresponding content 50 to the corresponding base stations 9₁, 9₂ for broadcasting in corresponding cell 8₁, 8₂. In this example, the SGSN 5₂ forwards IP packets 56_{1A}, 56_{1B}, 56_{1C}, 56_{2A}, 56_{2B}, 26_{2C}, 56_{3A}, 56_{3B}, 56_{3C} to the first base station 9₁ for broadcasting in the first cell 8₁.

Mobile stations may then receive the corresponding content 50 broadcast in their cell 8₁, 8₂. For example, the mobile station 10₁ begins to receive and parse IP packets 56_{1A}, 56_{1B}, 56_{1C}, 56_{2A}, 56_{2B}, 56_{2C}, 56_{3A}, 56_{3B}, 56_{3C} carrying content relating to items 45₁, 45₂, 45₃ in the first sessions 44₁ to content database 37 (FIG. 5) for storing and/or to content browser 38 (FIG. 5) for immediate presentation to the user.

The mobile station 10₁, 10₂′, 10₃, 10₄, 10₅, 10₆ transmits a notification that it is continuing to consume the content (step S17).

In this example, while the mobile station 10₁ receives and parses IP packets 56_{1A}, 56_{1B}, 56_{1C}, 56_{2A}, 56_{2B}, 56_{2C}, 56_{3A}, 56_{3B}, 56_{3C}, it periodically send a notification 57 (FIG. 13) to the ratings centre 3 informing the ratings centre 3 that it is still consuming items 45₁, 45₂, 45₃.

The mobile station 10₁, 10₂, 10₃, 10₄, 10₅, 10 transmits a notification that it is finished consuming content (step S18). The ratings centre 3 transmits an instruction to the network element to cease transmitting content if the number of mobile stations 10₁, 10₂, 10₃, 10₄, 10₅, 10₆ is below the minimum number (step S19). Thus, content ceases to be transmitted in the cell (step S20). In this example, this happens as follows:

If the ratings centre 3 receives further notifications 57 and determines that the counted number of mobile stations in the same cell wishing to receive or continue receiving a session still exceeds the minimum number, then it allows the broadcast to continue. However, if the counted number falls below the minimum number then it transmits an instruction to the SGSN 5₂ to stop transmitting content 50 in the corresponding cell 8₁, 8₂.

If the SGSN 5₂ receives the instruction from the ratings centre 3 to cease transmitting some of the content 50 in a particular cell 8₁, 8₂, then it stops forwarding the corresponding content 50 to the corresponding base station 9₁, 9₂ or, if the content has already been forwarded, transmits an instruction to the corresponding base station 9₁, 9₂ not to broadcast the corresponding content 50.

In this case, the ratings centre 3 periodically receives notifications 57 from the mobile station 10₁ that the mobile station 10₁ is still consuming items 45₁, 45₂, 45₃ (FIG. 7).

The user indicates that he or she no longer wishes to watch the Business News.

The mobile terminal 10₁ sends a notification 57 (FIG. 13) to the ratings centre 3 that it is has finished consuming items 45₁, 45₂, 45₃. The ratings centre 3 transmits an instruction to the SGSN 5₂ to stop transmitting corresponding content 50 and the SGSN 5₂ stops forwarding any unsent IP packets 56_{1A}, 56_{1B}, 56_{1C}, 56_{2A}, 56_{2B}, 56_{2C}, 56_{3A}, 56_{3B}, 563C to the first base station 9₁.

The process may be used to broadcast content 50 as and when required. For example, the first session may be broadcast in the first cell 8₁, but not the second cell 8₂.

Thus, mobile stations 10₁, 10₂, 10₃, 10₄, 10₅, 10₆ provide feedback as to whether they wish to receive content. Consequently, transmission of the broadcast content may be switched on and off in different regions according to whether end-users have shown interest in receiving the content. This has the advantage of freeing network resources.

Method of Operating a Ratings Centre 3

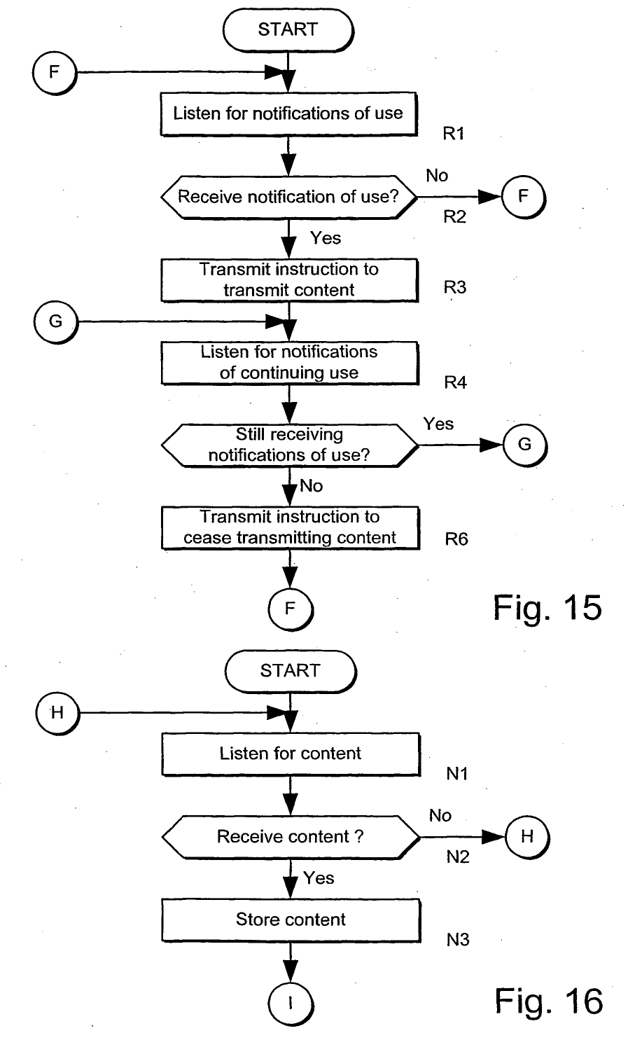

Referring to FIG. 15, a method of operating the ratings centre 3 for controlling broadcasting is shown.

The ratings centre 3 listens for notifications 57 (step R1) and determines whether it has received enough notifications in respect of the same session or item in a given region (step R2).

In this case, the ratings centre 3 groups notifications 57 (FIG. 12) according to session, and/or item, and according to cell 8₁, 8₂. It counts a number of mobile stations 10₁, 10₂, 10₃, 10₄, 10₅, 10₆ sending notifications 57 (FIG. 12) in respect of each session (or item) in each cell 8₁, 8₂. The number is compared to a predetermined threshold, which is usually one.

If the ratings centre 3 determines that it has received enough notifications in respect of the same session or item, then it instructs the network element 52 to forward content for the session for transmission in the given area (step R3).

In this case, the ratings centre 3 receives a notification 57 (FIG. 12) from the first mobile 10₁ that it wishes to consume items 45₁, 45₂, 45₃ included in the first session 44₁. The predetermined threshold is one. Therefore, the ratings centre 3 transmits an instruction to the SGSN 5₂ to transmit IP packets 56_{1A}, IB_{1B}, 56_{1C}, 56_{2A}, 56_{2B}, 56_{2C}, 56_{3A}, 56_{3B}, 56_{3C} in the first cell 8₁.

The ratings centre 3 listens for notifications in respect of the session or item (step R4).

If the ratings centre 3 determines that it still receives enough notifications in respect of the same session or item, then allows the network element 5₂ to forward content for the session for transmission in the given area, otherwise it instructs the network element 5₂ to cease forwarding the content (step R5).

Method of Operating a Network Element 5₂

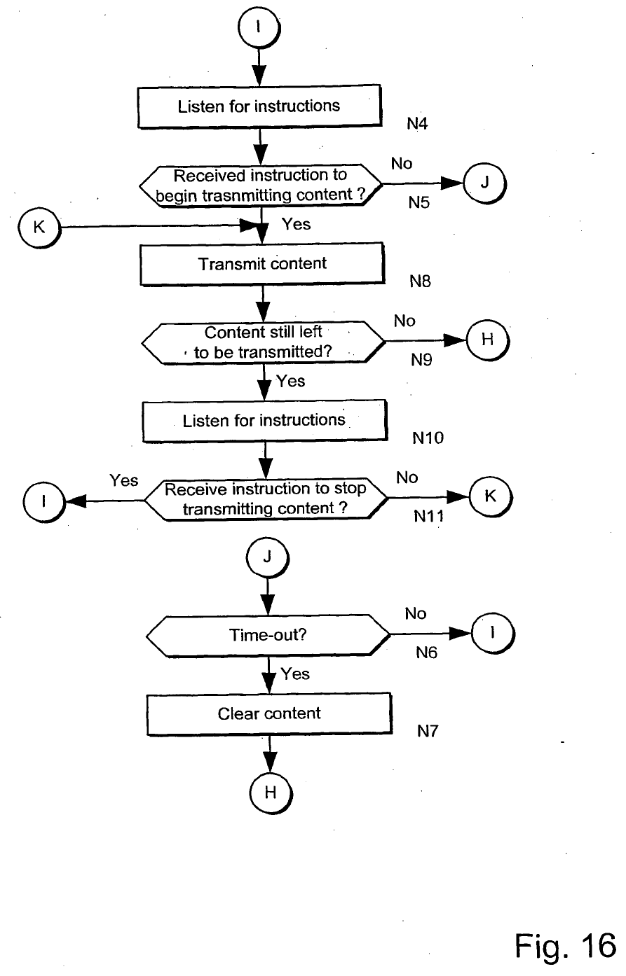

Referring to FIG. 16, a method of operating a network element 5₂ for controlling broadcasting is shown.

The network element 52 listens for content from the service delivery platform 2 (step N1). If the network element 52 receives content, then it stores the content 50 in storage (not shown) (steps N2 & N3).

In this example, the network element 5₂ is the SGSN 5₂ and the content 50 includes content 51₁, 51₂, 51₃ for each item 45₁, 45₂, 45₃ (FIG. 7) included in the first session 44₁ (FIG. 7). The content 51₁, 51₂, 51₃ is included in IP packets 56_{1A}, 56_{1B}, 56_{1C}, 56_{2A}, 56_{2B}, 56_{2C}, 56_{3A}, 56_{3B}, 56_{3C}. The content 51₁, 51₂, 51₃ may accompanied with instructions as to how long to store the data.

The network element 5₂ then listens for instructions from the service delivery platform 2 (step N4).

The network element 52 determines whether an instruction to begin transmitting content is received (step N5).

If no instructions are received, then network element 52 checks whether the period for transmitting the content has expired (step N6). If so, the network element 52 clears the content from storage (not shown) (step N7) and begins listening once more for content. Otherwise, the network element 52 continues to listens for instructions.

If instructions are received, then the network element 5₂ takes content from storage (not shown) and forwards it for transmission (steps N8). The instructions include details of the intended destination of the content.

For example, the SGSN 52 receives an instruction from the ratings centre 3 to forward content 51₁, 51₂, 51₃ for each item 45₁, 45₂, 45₃ (FIG. 7) included in the first session 44₁ (FIG. 7) to the first cell 8₁. The SGSN 5₂ begins to forward the IP packets 56_{1A}, 56_{1B}, 56_{1C}, 56_{2A}, 56_{2B}, 56_{2C}, 56_{3A}, 56_{3B}, 56_{3C} to the first base station 9₁ for broadcasting in the first cell 8₁.

The network element 5₂ determines whether there is content left to forward (step N9).

If there is no content left to forward, then it listens once more for content If there is content left, then it listens for further instructions from the service delivery platform 2 (step N10).

The network element 5₂ determines whether an instruction is received to stop transmitting content is received (step N11).

If no instruction is received, then the network element 5₂ continues to fetch content from storage (not shown) and forward it for transmission.

However, if an instruction is received to stop transmission, then transmission is suspended and the network element 5₂ listens for instructions to restart transmitting remaining content.

DVB-T & UMTS System

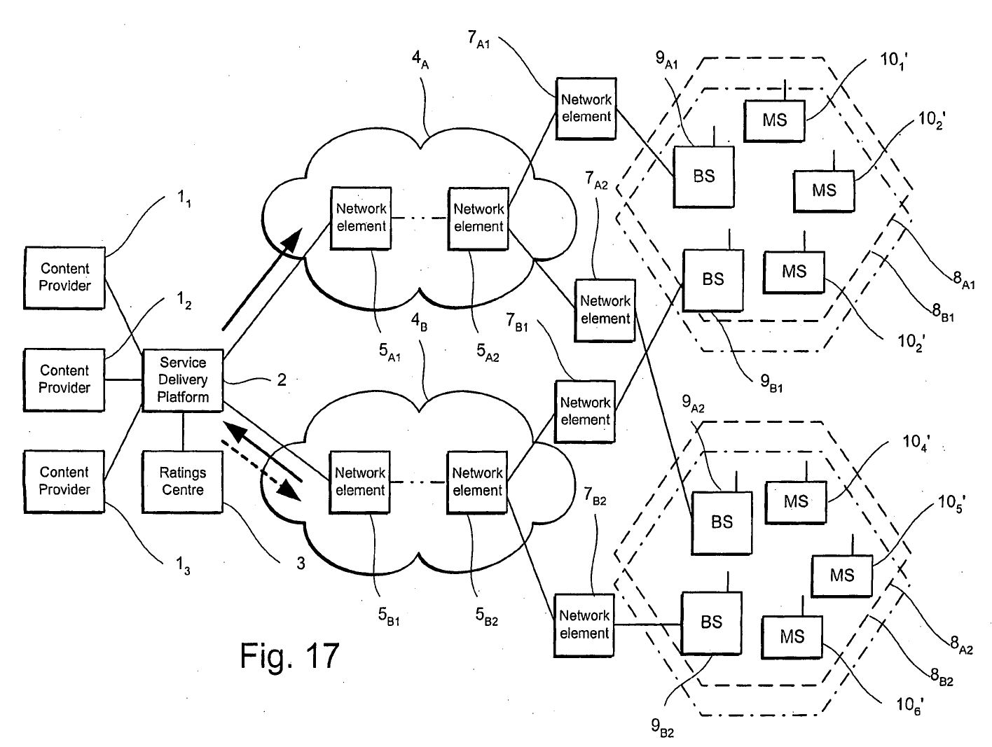

Referring to FIG. 17, another system for delivering content and returning feedback is shown. The system includes at least one content provider 1₁, 1₂, 1₃, a service delivery platform 2 and a ratings centre 3.

The system includes a first core network 4_{A}, which includes at least one network element 5_{A1}, 5_{A2}, and a first access network 6_{A}. The first access network 6_{A} may include network elements 7_{A1}, 7_{A2} and include at least one wireless cell ⁸_{A1}, 8_{A2} served by respective base stations 9_{A1}, 9_{A2}.

The system includes a second core network 4_{B}, which includes at least one network element 5_{B1}, 5_{B2}, and a first access network 6_{B}. The second access network 6_{B} may include network elements 7_{B1}, 7_{B2} and include at least one wireless cell 8_{B1}, 8_{B2} served by respective base stations 9_{B1}, 9_{B2}.

First base stations 9_{A1}, 9_{B1} of the access networks 6_{A}, 6_{B} serve a first set of terminals in the form of dual-network mobile stations 10₁′, 10₂′, 10₃′. Second base stations 9_{A2}, 9_{B2} of the access networks 6_{A}, 6_{B} serve a second set of terminals in the form of dual-network mobile stations 10₄′, 10₅′, 10₆′.

In this example, the first network 4_{A}, 6_{A} is or forms part of a terrestrial Digital Video Broadcasting (DVB-T) network.

The first core network 4_{A} is a packet-based network and the network elements 5_{A1}, 5_{A2} may be routers.

The first access network 6_{A} is also a packet-based network and the network elements 7_{B1}, 7_{B1} may each be a multiprotocol encapsulator (MPE) or an IP encapsulator (IPE). The base stations 9_{A1}, 9_{A2} may each comprise DVB-T transmitter for transmitting orthogonal frequency divisional multiplexing (OFDM) signals.

In this example the second network 4_{B}, 6_{B} is or forms part of a universal mobile telephone system (UMTS) network. In this example, the UMTS is not used for broadcasting but rather for point-to-point communication with the ratings server 17 (FIG. 3).

The second core network 4_{B} is a packet-based network and the network elements 5_{B1}, 5_{B2} may be a gateway general packet radio service (GPRS) service node (GGSN) and a serving GPRS service node (SGSN) respectively.

The second access network 6_{B} is also a packet-based network and the network elements 7_{B1}, 7_{B2} may be radio network controllers (RNC). The base stations 9_{B1}, 9₂ may each comprise a base station node B for transmitting according to a wideband code division multiple access (WCDMA) specification.

The second network 4_{B}, 6_{B} may be a public land mobile network (PLMN) network, such as a GSM network, a wired network, such as a public switched telephone network (PSTN) or cable network, or the Internet.

The first network 4_{A}, 6_{A} is used to transmit the ESG, including a request for feedback, and content to the mobile stations 10₁′, 10₂′, 10₃′, 10₄′, 10₅′, 10₆′ according to any of the methods described earlier. The second network 4_{B}, 6_{B} is used to provide feedback from the mobile stations 10₁′, 10₂′, 10₃′, 10₄′, 10₅′, 10₆′ to the ratings server 17 (FIG. 3) according to any of the methods described earlier.

Mobile Stations 10₁′, 10₂′, 10₃′, 10₄′, 10₅′, 10₆′

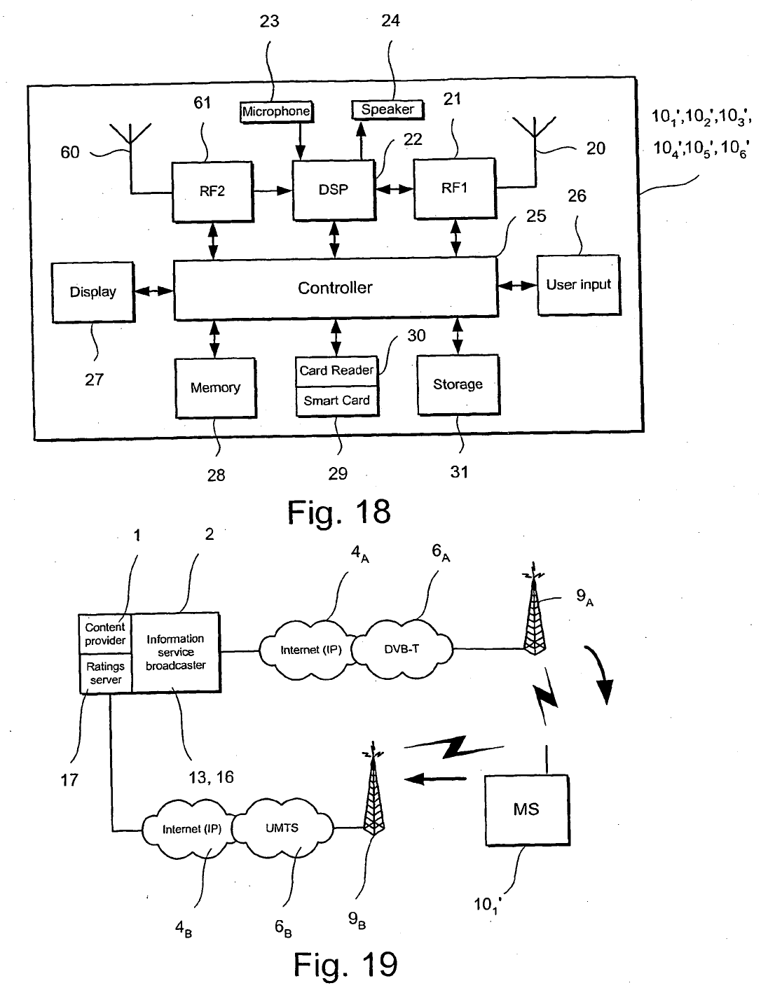

Referring also to FIG. 18, the mobile stations 10₁′, 10₂′, 10₃′, 10₄′, 10₅′, 10₆′ are similar to the mobile stations 10₁′, 10₂′, 10₃′, 10₄′, 10₅′, 10₆′ described earlier but also include another antenna 60 and another radio frequency section 61 so allowing them to be used with two types of network. A single antenna may be used for the radio frequency sections 21, 58.

In this example, the radio frequency section 21 is suitable for modulating/de-modulating and amplifying signals received via the UMTS network 4_{B}, 6_{B} and the other radio frequency section 61 is suitable for de-modulating and amplifying signals received via DVB-T network 4_{A}, 6_{A}. In other words, in this example the mobile stations 10₁′, 10₂′, 10₃′, 10₄′, 10₅′, 10₆′ are integrated 3G/DVB-T mobile terminals.

DVB-T & UMTS System

Referring to FIG. 19, a system for delivering content to and returning feedback from a receiving station 10₁′ is shown. A portion of the system for delivering content to the receiving station 10₁′ comprises a broadcast server 2, the Internet 4_{A}, a DVB-T system 6_{A} and a radio transmitter tower 9_{A}. The broadcast server 2 includes a content provider 1, a service broadcast servers 13, 16, which includes software for generating IP streams and corresponding IP session announcements at plural levels, as SAP messages, and a rating server 17. A portion of the system for returning feedback to the ratings device 17 comprises the Internet 4_{B}, a UMTS network 6_{B} and a radio transmitter tower 9_{B}.

IP streams and IP session announcements 47₁, 47₂, 47_{N} (FIG. 9) generated by the broadcast server 2 are provided by servers 13, 16, via the Internet 4_{A}, to the DVB-T system 6_{A}. Here, the IP streams and IP session announcements are prepared before being broadcast by the radio transmitter tower 9_{A}. The receiving station 10₁′ receives session announcements 47₁, 47₂, 47_{N} (FIG. 9) which include an instruction to transmit a notification 57 (FIG. 12) if the receiving station 10₁′ wishes to receive a session 44₁, 44₂ (FIG. 7), continue to receive a session or cease to receive a session, in a manner similar to that described earlier.

The receiving station 10₁′ transmits a notification 57 (FIG. 12) for indicating that it wishes to consume content, continue receiving content or cease receiving content, the notification being transmitted through UMTS 6_{B} and Internet 4_{B} to ratings server 17, in a manner similar to that described earlier.

It will be appreciated that many modifications may be made to the embodiments hereinbefore described.

For example, the system for delivering content may include more than service delivery platform, more than one ratings centre, more than one core network and more than one access network which communicate and share information.

Different transport protocols may be used, such as RTP. The instruction may be transmitted in an application layer, in an IP layer or in a signalling layer.

An asynchronous transfer mode (ATM) backbone network and a wireless local area network (WLAN) may be used as core and access networks respectively using an interconnecting edge router.

Internet Group Management Protocol (IGMP) messages may be used to transmit a schedule and include an instruction to notify a given party of consumption of content.

The broadcasting system may be a digital audio broadcasting (DAB) system, an integrated services digital broadcasting (ISDB) system, such as a television ISDB system (ISDB-T), or another DVB system, such as a satellite DVB (DVB-S) system or cable DVB (DVB-C) system.

An integrated GPRS/DVB-T mobile terminal may be used instead of a 3G/DVB-T mobile terminal.

The receiver stations need not be mobile, but may be fixed. For example, the receiver station may be integrated into a digital television set or digital television set-top box.

Different receiving stations of different types may be used within the system, for example some receiving stations may be mobile and some may be fixed. Additionally or alternatively, receiving stations may provide feedback through different networks. For example, one receiving station may provide feedback though a 3G network and second receiving station may provide feedback though the Internet via a wired link.

1-32. (canceled)

33. A method of gathering information relating to consumption of broadcast content, the method comprising:
preparing a description of the content;
adding to said description an instruction to notify a given party of one of the group comprising intended reception of said content and consumption of said content; and
transmitting said description to a plurality of receiving stations.

34. A method according to claim 33, comprising:
preparing a schedule for broadcasting content; and
including said description in the schedule;
wherein transmitting said description to the plurality of receiving stations comprises transmitting said schedule to the plurality of receiving stations.

35. A method according to claim 33, comprising adding to said description an instruction to notify said given party of intended continued reception of said content.

36. A method according to claim 33, comprising adding to said description an instruction to notify said given party of intended cessation of reception of content.

37. A method according to claim 33, comprising broadcasting said content if a receiving station notifies said given party that it intends to receive said content.

38. A method according to claim 33, comprising receiving notifications from receiving stations.

39. A method according to claim 33, comprising counting a number of receiving stations which notify said given party that they intend to receive said content.

40. A method according to claim 33, comprising counting a number of receiving stations which notify said given party that they are receiving said content.

41. A method according to claim 33, comprising preparing said description of said content according to the Session Description Protocol.

42. A method according to claim 33, further comprising identifying a region from which said notification is received and transmitting said item of service in said region.

43. A method according to claim 33, further comprising identifying a region from which a notification is received and broadcasting said content in said region.

44. A method according to claim 33, further comprising identifying a region from which no notification is received and not broadcasting said content in said region.

45. A method, in a receiving station, of providing information relating to consumption of broadcast content, the method comprising:
receiving a description of said content;
determining whether an instruction has been added to said description, said instruction being to notify a given party of one of the group comprising intended reception of said content and consumption of the said content; and
if determined that said instruction is added to said description, then transmitting, to said given party, a notification of intended reception of said content.

46. A method according to claim 45, comprising:
receiving a schedule of broadcasting content, said schedule including the description of said content.

47. A method according to claim 45, comprising:
receiving said content.

48. A method according to claim 47, further comprising:
transmitting, to said given party, a notification of intended continued reception of said content.

49. A method according to claim 48, further comprising:
transmitting, to said given party, a notification of intended cessation of reception of said content.

50. A method of controlling a broadcasting network, said broadcasting network including a base station for broadcasting content in a predetermined region, said method comprising:
counting a number of notifications of intended reception of broadcast content received from receiving stations located in said predetermined region and
if said number of notifications equals or exceeds a predetermined number, broadcasting said content in said predetermined region.

51. A method according to claim 50, further comprising:
preparing a description of broadcast content;
adding to said description an instruction to notify a given party of intended reception of said content; and
transmitting said description to a plurality of receiving stations.

52. A method according to claim 50, further comprising:
if said number of notifications falls below said predetermined number, stopping broadcast of said content in said predetermined region.

53. A computer program product storing a computer program comprising instructions which, when executed by data processing apparatus, causes said data processing apparatus to perform the method according to claim 33.

54. Apparatus for gathering information relating to consumption of broadcast content, the apparatus comprising:
a processor for preparing a description of the content and adding to said description an instruction to notify a given party of one of a group comprising intended reception of said content and consumption of said content; and
a transmitter for transmitting said description to a plurality of receiving stations.

55. Apparatus for controlling a broadcasting network, said broadcasting network including a content provider, a network element for routing content and a base station for broadcasting content in a predetermined region, said apparatus comprising:
a receiver for receiving, from receiving station, a notification of intended reception of broadcast content;
a processor for determining whether said notification is received from a receiving station located in said predetermined region and
transmitter for instructing said network element to route said content to said base station for transmission in said predetermined region.

56. A receiving station for providing information relating to consumption of broadcast content, the receiving station comprising:
a receiver for receiving a description of said content;
a processor for determining whether an instruction has been added to said description, said instruction being to notify a given party of one of a group comprising intended reception of said content and consumption of said content; and
a transmitter for transmitting, to said given party, a notification of intended reception of said content if said instruction is added to said description.

57. A system for presenting program schedule data on a display of receiving station, said system comprising at least a schedule data for broadcasting content, the schedule data being organized to include at least partly an instruction to notify a given party of consumption of content.
